(19) United States
(12) Patent Application Publication
(10) Pub. No.: US 2024/0217363 A1
(43) Pub. Date: Jul. 4, 2024

(54) ELECTRIC VEHICLE CHARGING SITES

(71) Applicant: Veloce Energy, Inc., Los Angeles, CA (US)

(72) Inventors: Jeffery D. WOLFE, Houston, TX (US); Michael SCHENCK, San Rafael, CA (US)

(21) Appl. No.: 18/503,709

(22) Filed: Nov. 7, 2023

Related U.S. Application Data
(63) Continuation of application No. PCT/US2022/029059, filed on May 12, 2022.
(60) Provisional application No. 63/188,344, filed on May 13, 2021.

(51) Int. Cl. B60L 53/53; B60L 53/30; B60L 53/62; H01M 50/24; H02J 3/32

(52) U.S. Cl. CPC B60L 53/53; B60L 53/30; B60L 53/62; H01M 50/24; H02J 3/32; H02J 2300/26; H02J 2300/28

(57) ABSTRACT

The present disclosure provides systems for charging electric vehicles. A system may comprise an electrical load comprising an electrical vehicle (EV) charging site, wherein the EV charging site comprises a plurality of EV chargers and a plurality of battery energy storage systems (BESSs); a main utility feed that connects the electrical load to a power grid, wherein the main utility feed has a power capacity; a sensor configured to measure power on the main utility feed; and a controller communicatively coupled to the sensor and the plurality of BESSs, wherein the controller is programmed to cause: (i) a subset of the BESSs to charge using power from the main utility feed when the power on the main utility feed does not exceed a threshold, and (ii) a subset of the BESSs to discharge power when the power on the main utility feed does exceed the threshold.

### CROSS-REFERENCE

This application is a continuation of International Application No. PCT/US2022/029059, filed May 12, 2022, which claims the benefit of U.S. application No. 63/188,344, filed May 13, 2021, each of which is incorporated by reference herein in its entirety.

### BACKGROUND

Power distribution systems can distribute power to many locations across a site. A site may have an electric vehicle (“EV”) charging site and multiple buildings. The EV charging site may have multiple EV charging stations with different use patterns. The buildings may have individual loads that have more predictable use patterns than the EV charging site. In some cases, a power distribution system distributes power in a large feeder that carries all the required power for the site to the first point of power use, where it is terminated at a main breaker that is sized to supply the entire site. Further power distribution may be from individual breakers at a main distribution panel (“MDP”). This method of power supply may make future expansion difficult, as new loads may need to be fed from the MDP, which may require expensive and difficult wiring runs. Adding new loads may also require a utility upgrade.

### SUMMARY

The present disclosure provides systems and methods that may comprise a power distribution system that allows for less expensive initial installation and expansion. The power distribution system may have a reduced-size main utility feed. Distributed energy resources (e.g., battery energy storage system) may be located at various locations around the site. The main utility feed may run across the site at a uniform size and may supply all the site's power. In place of MDPs, the utility power may be connected to specialized battery energy storage systems at each location. An MDP may be integrated into or installed adjacent to each battery energy storage system (BESS). Individual overcurrent protection devices may be directly integrated into the power distribution system instead of located in an MDP or BESS.

The main utility feed may also run across the site at a non-uniform size apportioning power controlled by a power flow control system. This control system may be a power electronic device regulating power flow or may be a load apportionment system.

The power distribution system may be a direct current (“DC”) system. A DC system can support power flow from multiple directions converging on a single point or multiple points. Alternatively, the power distribution system may be an alternating current (“AC”) system. Any point of connection to the AC system may have bidirectional power flow (may enable power flow in both forward and reverse directions). An AC system may have multiple switches that enable isolation of certain loops on the site. The isolated loops may be configured in real-time. The isolated loops may accommodate different supply and load patterns.

The power distribution system may be controlled based on the following principles: (1) power flow through the main feeder may be actively limited to the legal feeder capacity; (2) power may be discharged from the local battery energy storage systems to meet any load above the capability of the feeder or utility connection; (3) power may be discharged from local battery energy storage systems to serve non-local loads at other locations on the site; (4) the battery energy storage systems may be recharged whenever there is spare power capacity in the main feeder and (5) regulations (National Electrical Code (NEC), National Fire Protection Association (NFPA) 70E, UBC, etc.) may induce sizing regulations of the capacity of the feeder. In some cases, the power distribution system may be controlled according to a load schedule, a utility tariff, or other outside influence. Power (current) flow in the power distribution systems may also be controlled based at least in part on external ambient temperatures. NFPA 70E, specifically the NEC, may require that conductors be sized per continuous current and required multipliers of the calculated current flow. The current flow in a conductor may be based on ambient conditions expected locally that may be different than those specified during design. As such, a limiting element of current flow in a conductor may be dependent on the temperature rating and a LMS (Load Management System) or EMS (Energy Management System)

In an aspect, the present disclosure provides a system comprising an electrical load comprising an electrical vehicle (EV) charging site, wherein the EV charging site comprises a plurality of EV chargers and a plurality of battery energy storage systems; a main utility feed that connects the electrical load to a power grid, wherein the main utility feed has a power capacity; sensors configured to measure power on the main utility feed and/or other locations in the system; and one or more controllers communicatively coupled to the sensors and the plurality of battery energy storage systems, wherein the controller is programmed to cause: (i) a subset of the plurality of battery energy storage systems to charge using power from the main utility feed when the power on the main utility feed does not exceed a threshold, and (ii) a subset of the plurality of battery energy storage systems to discharge power when the power on the main utility feed or another section of the power distribution system does exceed the threshold.

In some embodiments, the electrical load further comprises a building, and wherein the discharged power in (ii) is transmitted to the building. In some embodiments, the discharged power in (ii) is transmitted to the plurality of EV chargers. In some embodiments, the system further comprises a conductor in electrical communication with the main utility feed, wherein the conductor transmits power to one or more EV chargers of the plurality of EV chargers and one or more battery energy storage systems of the plurality of battery energy storage systems. In some embodiments, the one or more EV chargers are arranged in parallel along a length of the conductor, and wherein the conductor is reduced in size along the length. In some embodiments, the conductor is disposed in an overhead cable or bus. In some embodiments, the overhead cable or bus comprises a support leg adjacent to an EV charger of the one or more EV chargers. In some embodiments, the support leg comprises an internal cavity for routing power and communication cables to the EV charger. In some embodiments, the overhead cable or bus comprises lighting. In some embodiments, the overhead cable or bus comprises one or more electronic displays. In some embodiments, the overhead cable or bus comprises one or more cameras. In some embodiments, the overhead cable or bus comprises one or more wayfinding systems. In some embodiments, the conductor is configured to transmit direct current (DC) power. In some embodiments, the system further comprises a plurality of alternating current (AC)-to-DC converters configured to convert AC power from the main utility feed to DC power and provide the DC power to the conductor. In some embodiments, the conductor is configured to transmit AC power to the one or more EV chargers. In some embodiments, the system further comprises a centralized transformer configured to provide galvanic isolation between the power grid and the one or more EV chargers. In some embodiments, the system further comprises one or more transformers associated with the one or more EV chargers, wherein the one or more transformers are configured to provide galvanic isolation between the power grid and one or more EV chargers. In some embodiments, the one or more transformers are configured to convert the power grid to a lower voltage. In some embodiments, the one or more EV chargers are configured to provide DC power to EVs, and wherein the plurality of EV chargers comprise one or more AC-to-DC converters. In some embodiments, the sensor is a current relay. In some embodiments, the plurality of battery energy storage systems are interspersed with the plurality of EV chargers. In some embodiments, the system further comprises one or more renewable energy sources. In some embodiments, the one or more renewable energy sources comprise a solar array or a wind turbine. In some embodiments, the controller is programmed to implement maximum power point tracking of the one or more renewable energy sources. In some embodiments, an EV charger of the plurality of EV chargers is installed with an arc-fault detection device. In some embodiments, the arc-fault detection device comprises a series or parallel impedance configured to prevent propagation of an arc-fault detection signal. In some embodiments, a battery energy storage system of the plurality of battery energy storage systems comprises a plurality of cabinets. In some embodiments, the plurality of cabinets are connected via openings. In some embodiments, the openings comprise fire dampers. In some embodiments, the openings are between plinth bases under the cabinets. In some embodiments, a battery energy storage system of the plurality of battery energy storage systems comprises an environmental conditioning unit. In some embodiments, a battery energy storage system of the plurality of battery energy storage systems comprises a hose connection. In some embodiments, a battery energy storage system of the plurality of battery energy storage systems comprises a water drain. In some embodiments, the battery energy storage system comprises a heat or smoke sensor, wherein the heat or smoke sensor is communicatively coupled to the controller. In some embodiments, a battery energy storage system of the plurality of battery energy storage systems comprises a rectifier and a power inverter. In some embodiments, the plurality of EV chargers or the plurality of battery energy storage systems are disposed on a skid. In some embodiments, the plurality of EV charging stations or the plurality of battery energy storage systems comprise electrical backplanes. In some embodiments, a battery energy storage system of the plurality of battery energy storage systems comprises one or more electrochemical cells or other energy storage. In some embodiments, the threshold is the power capacity of the main utility feed. In some embodiments, the power capacity is less than a maximum power draw of the electrical load.

Another aspect of the present disclosure provides a non-transitory computer readable medium comprising machine executable code that, upon execution by one or more computer processors, implements any of the methods above or elsewhere herein.

Another aspect of the present disclosure provides methods that perform the functions of the systems described above or elsewhere herein.

Another aspect of the present disclosure provides a system comprising one or more computer processors and computer memory coupled thereto. The computer memory comprises artificial intelligence or machine learning that autonomously modifies machine executable code that, upon execution by the one or more computer processors, implements any of the methods above or elsewhere herein, or new methods discovered by the AI/ML.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 schematically illustrates an example of an EV charging site.

FIG. 2 schematically illustrates an example of a conductor that transmits power to EV charging stations.

FIG. 3 schematically illustrates an example of transformers for EV charging stations.

FIG. 4 schematically illustrates an example of a centralized transformer.

FIGS. 5A-5B show an example of an overhead cable bus.

FIG. 6 shows a computer system that is programmed or otherwise configured to implement methods provided herein.

FIG. 7 schematically illustrates a side view of the EV charging environment.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The present disclosure provides systems and methods that may comprise a power distribution system that allows for less expensive initial installation and expansion. The power distribution system may have a reduced-size main utility feed. Distributed energy resources (e.g., battery energy storage system) may be located at various locations around the site. The main utility feed may run across the site at a uniform size smaller than normally required, or at a smaller, but variable size, and may supply all the site's power. In place of main distribution panels (MDPs), the utility power may be connected to specialized battery energy storage systems at each location. An MDP may be integrated into or located adjacent to each battery energy storage system or may be integrated at many points along the power distribution system as individual devices or compound devices. The system may increase permissible power draw during times of emergency dispatch when other demand response (DR) loads may be reduced during times of natural disaster.

The power distribution system may be a direct current (“DC”) system. A DC system can support power flow from multiple directions to common points. Alternatively, the power distribution system may be an alternating current (“AC”) system. An AC system may have multiple switches (e.g., switches, breakers, contactors, relays, or other devices that physically interrupt the flow of electricity) that enable isolation of certain loops on the site. The isolated loops may be configured in real-time, and may be configured autonomously, and may use artificial intelligence or machine learning to decide configuration. The isolated loops may accommodate different supply and load patterns. Power flow into, out of, or along any loop may be in any direction. The loops may also have various DER. Temperature, load, overall system capacity, and fault characteristics (including excessive total harmonic distortion (THD) or noise), may be inputs to this switching behavior.

The power distribution system may be controlled based on the following principles: (1) power flow through the main feeder may be actively limited to the legal feeder capacity; (2) power may be discharged from the local battery energy storage systems to meet any load above the capability of the feeder or utility connection; (3) power may be discharged from local battery energy storage systems to serve non-local loads at other locations on the site; and (4) the battery energy storage systems may be recharged whenever there is power capacity in the main feeder, or as decided by an algorithm or prioritization scheme. In some cases, the power distribution system may be controlled according to a load schedule, utility tariff, or other outside influence. Power distribution may also be regulated during times of heavy demand or during limitation associated with a curtailment event due to natural disaster or due to a public safety power shutoff (PSPS, or similar shutoff under another name)—caused overall power reduction. Feeder sizing, when coupled with use of thermal sensors, may be used to increase the amount of current flowing in the feeder to the local load.

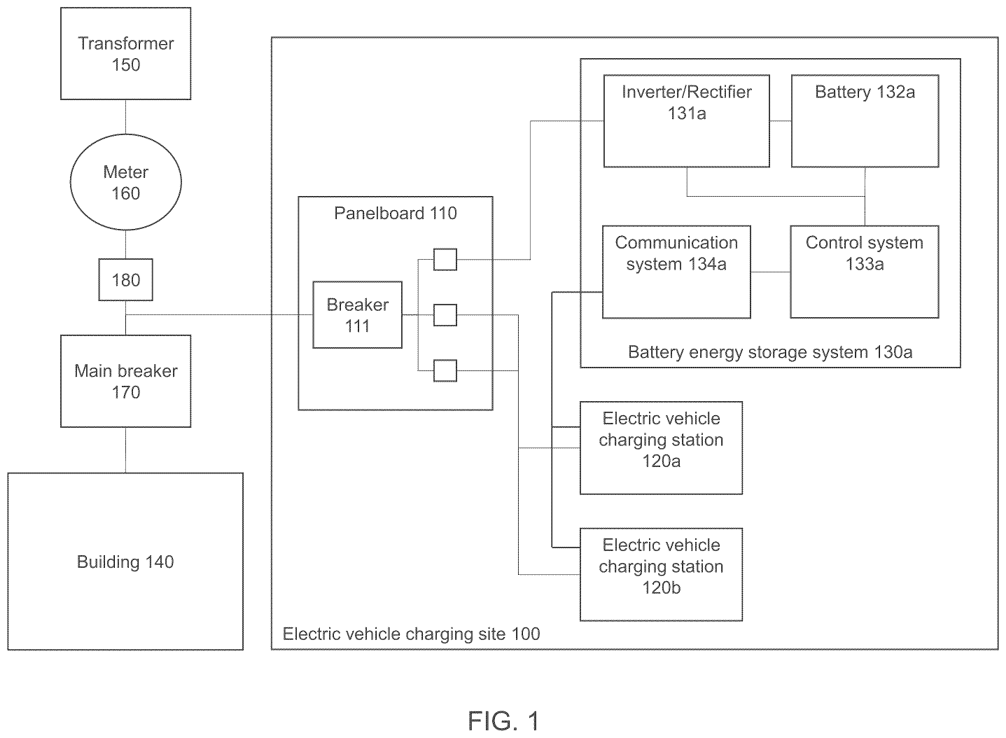

FIG. 1 schematically illustrates an electric vehicle (EV) charging site 100. The EV charging site 100 may have a panelboard 110, one or more EV charging stations 120, and one or more battery energy storage systems 130.

The panelboard 110 may have an overcurrent protection device 111 (e.g., circuit breaker). The overcurrent protection device 111 can protect downstream components (e.g., the EV charging stations 120) from overload conditions and short circuits. The overcurrent protection device 111 may have a sensor for detecting such overload conditions and short circuits. The overcurrent protection device 111 may also have a mechanism to automatically actuate the overcurrent protection device to the open or closed position. The panelboard 110 may also have one or more contactors or relays (e.g., one contactor or relay for each EV charging station 120 or battery energy storage system 130 in the EV charging site 100, and/or a relay for the entire panelboard 110). The over current device may be in the panelboard 110, or along the bus conductor carrying power from the MDP to the EV charger. In some embodiments, the power distribution across the site is on a bus that is continuously sized and provided power from the main site utility distribution breaker, and all other electrical loads or generating sources are directly connected to this bus through local taps, current devices, and circuit interrupting devices. These devices may have local control, or remote control through automatic or manual actuation. They may have remote annunciation of their status. They may power one or more devices. They may include transformers to change the voltage to match what is needed by the load.

The EV charging stations 120 may be conventional EV charging stations. The EV charging stations 120 may have power electronics, controllers, connectors, and communication devices. The power electronics may include transformers, inverters, voltage regulators, sensors, and the like. The EV charging stations 120 can supply alternating current (“AC”) power. The AC power may be single phase or three phase power. In some cases, the EV charging stations 120 supply between 6 amps and 80 amps of power at about 208 volts or 240 volts (i.e., between 1.4 and 19.2 kilowatts of power) (AC Level 2). Alternatively or additionally, the EV charging stations 120 can supply direct current (“DC”) power by rectifying AC power from the grid. In some cases, the EV charging stations 120 supply up to 80 kilowatts of power at 50-1000 volts (DC Level 1). In other cases, the EV charging stations 120 supply up to 400 kilowatts or more of power at 50-1000 volts or more. The controllers can control the rate of charge of EVs that use the EV charging stations 120. The controllers can also control access to the EV charging stations 120. For example, the controllers can authenticate access requests from EVs or other sources (e.g., driver's mobile devices). Other examples include that the controllers can enable actions (authentication, charging, control) based on a keypad code or a lock cylinder turn. The controllers can also implement payment functionality (e.g., credit card processing). The controllers can also provide control signals to the EVs via the connectors. The control signals may contain data about the charging process. The controllers can also process signals sent by the EVs regarding the charging process. The connectors can facilitate connection between the EV charging stations 120 and the EVs. The connectors may have power pins and control signal pins. The communication devices can enable the EV charging stations 120 to communicate data and control signals to remotely located devices (e.g., other EV charging stations, battery energy storage systems 130, and remote servers) over a wired or wireless network. Controllers may get additional signals from cameras, such as vehicle type, vehicle identification number (VIN) or license plate (through reading), RFID tags or stickers, “toll passes”, bar codes, etc. Use of thermal imaging devices may provide indication of loading on charging cables (dispenser cables) or the EV chargers directly.

The battery energy storage systems 130 may be interspersed with the EV charging stations 120. Each battery energy storage system 130 may have an inverter/rectifier 131, a battery 132, a control system 133, and a communication system 134. The inverter/rectifier 131 can convert AC power from the grid to DC power for the battery 132, or it can convert DC from the battery 132 to AC. The inverter/rectifier 131 may have a DC-DC converter. In other cases, the inverter/rectifier may be replaced by a DC-DC converter that is fed by a distributed energy management resource system (DERMS) such as solar, fuel cells, or another similar system. Similarly, the DC-DC converter may also supply DC power to the EV charging stations directly. The DC-DC converter can increase or decrease the voltage of the DC supplied by or provided to the battery 132. The battery 132 can store energy. The battery 132 can be charged during off-peak times (e.g., when demand is less than a maximum threshold) or at any other time commanded. The battery 132 can be discharged for use by the EV charging stations 120 or the building 140 at any time. The battery 132 may have one or more electrochemical cells. The chemistry of the one or more electrochemical cells may be lithium-ion, lithium-polymer, sodium-sulfur, lead-acid, nickel-cadmium, or the like. The battery may alternately be one or more mechanical cells, one or more fuel cells, or other energy storage or conversion mechanisms. The control system 133 can control the operation of the inverter/rectifier 131 and the battery 132. For example, the control system 133 can increase or decrease the amount of current supplied to the inverter/rectifier 131 or the rate of discharge of the battery 132. The control system 133 can control these parameters by transmitting control signals to various electronic components in the battery energy storage system 130, including relays, transistors, and the like. The control system 133 may have one or more computers that are programmed to implement a control algorithm to determine the control signals. The control algorithm may be a machine learning algorithm. The machine learning algorithm may be trained to implement predictive control of the battery energy storage system 130, forecast available power and loads, or optimize the battery energy storage system for cost, battery cycles, reliability, or emergency response. The communication system 134 can communicate with other electronic devices both internal and external to the EV charging site 100 through wired or wireless networks. For example, the communication system 134 can communicate with the current relay 180 as described in greater detail below.

The EV charging site 100 may be associated with a building 140 (e.g., an apartment complex, a grocery store, shopping mall, commercial facility, academic building, or the like). A transformer 150 can supply grid power to the building 140 and the EV charging site 100. The building 140 may have a meter 160 and a main breaker 170. The meter 160 can determine the amount of power used by the building 140 and the EV charging site 100, and the main breaker 170 can prevent the building 140 from exceeding current limits. The sum of the capacity of the main breaker 170 and the overcurrent protection device 111 may be larger than the capacity of the transformer 150 due to the battery energy storage systems 120. This may allow the grid connection to be smaller than normal, reducing costs. The EV charging site 100 may be connected to grid power either before the main breaker 170 (e.g., as depicted in FIG. 1) or after the main breaker 170, depending on the local electrical code In some cases (e.g., when the EV charging site 100 is connected to grid power before the main breaker 170), the EV charging site 100 may have a separate electrical meter. A current relay 180 may be disposed after the meter 160 (e.g., as depicted in FIG. 1), or before the meter 160 but after the transformer 150. The current relay 180 can detect the total current drawn by the EV charging site 100 and the building 140. Additional current relays may be disposed near or inside each BESS.

The current relay 180 can transmit a signal to the communication system 134 of the battery energy storage system 130. The signal may specify the total current drawn by the EV charging site 100 and the building 140. The current relay 180 may transmit the signal on a continuous or period basis. For example, the current relay 180 can transmit the signal about every microsecond, millisecond, second, 10 seconds, 1 minute, or more. The communication system 134 can then transmit the signal to the control system 133. The control system 133 can process the signal with a control algorithm to maintain the current at or below the capacity of the transformer 150. The output of the control algorithm may be a control signal which causes the inverter/rectifier 131 to increase the current that it draws from the grid (i.e., if the transformer 150 has additional capacity), decrease the current that it draws from the grid (i.e., if the transformer has little or no additional capacity), and/or increase or decrease the current provided by the battery 132. The current relay 180 can also transmit signals to the EV charging stations 120 directly or through the control system. The signals may cause the EV charging stations 120 to increase or decrease their current draw. The current relay 180 can also transmit a signal to the overcurrent protection device 111. The signal may cause the overcurrent protection device 111 to trip in the case of an overload or short circuit. In some cases, a power or temperature sensor can be used in place of or in addition to the current relay 180. When multiple BESSes are distributed across the site, multiple current sensors can provide signals to increase or decrease current flow in each section of bus to keep each section below required current levels. Each electrical connection to the bus can have a meter to measure kW, kWh, time, and direction. This data can be used to determine total power flows in each section, allowing all power inflow and outflow to be known to adjust the total power flow of each section.

The EV charging site 100 described in FIG. 1 provides numerous advantages. First, it can be connected to a building power system that has no spare power capacity at peak because it can utilize spare power available during off-peak times. Second, it can accommodate changes to the building power system through the addition or subtraction of battery energy storage systems or through the addition or subtraction of batteries in a particular battery energy storage system. Third, it can have a smaller and less expensive connection to grid power than traditional EV charging sites because the battery energy storage systems can provide power during peak demand. Fourth, it may be more resilient than traditional EV charging sites that rely solely on grid power.

The control system 133a of FIG. 1 can be implemented on one or more computing devices. The computing devices can be servers, desktop or laptop computers, electronic tablets, mobile devices, or the like. The computing devices can be in one or more locations. The computing devices can be at the EV charging site, distributed among multiple EV charging sites, or at other locations. The computing devices can have general-purpose processors, graphics processing units (GPU), application-specific integrated circuits (ASIC), field-programmable gate-arrays (FPGA), or the like. The computing devices can additionally have memory, e.g., dynamic or static random-access memory, read-only memory, flash memory, hard drives, or the like. The memory can be configured to store instructions that, upon execution, cause the computing devices to implement the functionality of the subsystems. The computing devices can additionally have network communication devices. The network communication devices can enable the computing devices to communicate with each other and with any number of user devices, over a network. The network can be a wired or wireless network. For example, the network can be a fiber optic network, Ethernet® network, a satellite network, a cellular network, a Wi-Fi® network, a Bluetooth® network, or the like. In other implementations, the computing devices can be several distributed computing devices that are accessible through the Internet. Such computing devices may be considered cloud computing devices.

### Tapped Conductor

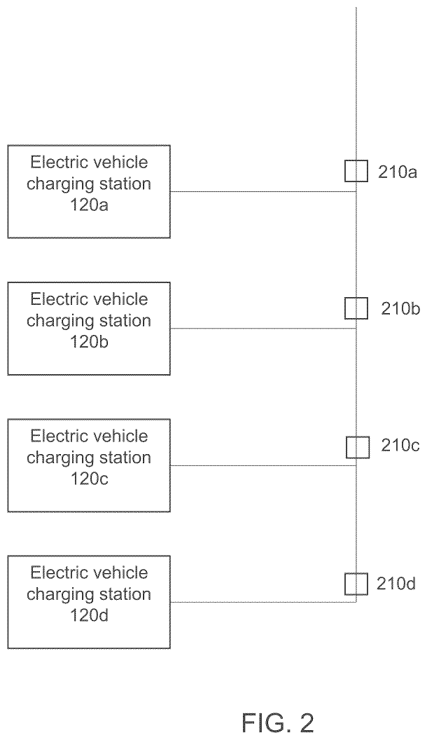

The conductor that feeds the EV charging stations 120 and the battery energy storage systems 130 may be a tapped conductor with protection devices that allow the size of the conductor to be reduced as it carries power away from the main distribution point. The protection devices may be series fuses, breakers, fused disconnects, or electronic disconnecting devices (e.g., contactors or relays and current sensors). FIG. 2 schematically illustrates such a conductor. In traditional tapped conductor, the conductor must be sized for the maximum current present on the circuit. However, if molded series fuses 210a to 210d are installed along the conductor as shown in FIG. 2, the conductor can be reduced in size after each subsequent EV charging station 120. For example, at the main distribution point, the conductor may be sized to support 200 amps, and the molded fuse 210a may be rated for 200 amps. The EV charging station 120A, however, may consume 50 of the 200 amps. As such, after the EV charging station 120A, the conductor may be sized to support only 150 amps, and the molded fuse 210b may be rated for 150 amps. At the end of the string of 4 EV charging stations 120, the conductor may be sized to support only 50 amps. Each fuse may be rated to handle the expected fault current on the branch. The fuses may be located in an over-molded assembly. The EV charging stations 120, when active, can detect a conductor or phase loss and shut down—and annunciate the issue to the main control system. Non-fused disconnect switches, contactors, or relays may be installed in each tap to permit isolation of the circuit if necessary. The taps may be of smaller size to permit cost savings. The conductor may be located in an overhead cable tray, conduit, or bus or underground. This concept may be applied to AC or DC systems. Lights and other small loads may be installed with appropriately sized conductor with insulation piercing connectors/over-molded assemblies and series installed fuses or as a separate power system and independent controllers, all housed in the same enclosure.

### Three-Phase Power Sources

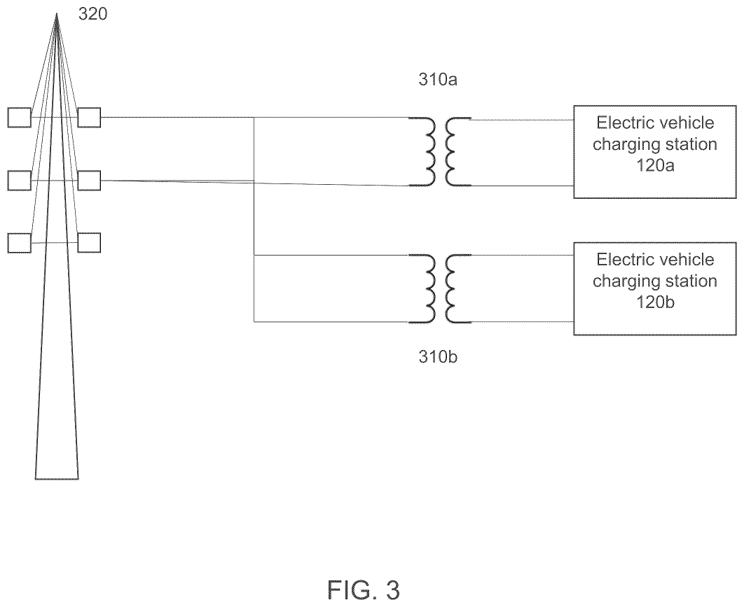

FIG. 3 schematically illustrates the EV charging stations 120 of FIG. 1, according to some embodiments of the present disclosure. The EV charging stations 120 in FIG. 2 may be AC Level 2 chargers. AC Level 2 chargers use 208-volt or 240-volt single-phase AC power. AC Level 2 chargers do not convert voltage; they merely provide varying amounts of power at whatever voltage is provided to them. Because many EVs are limited to 264-volt power, AC Level 2 chargers may not work on certain single and three-phase grid systems that provide higher voltage power. For example, almost all larger power systems in North America operate at 480-volt three phase or higher. Nearly all EV chargers of 50 kW and larger operate at 400V and higher three phase power. Therefore, a station with both higher power and Level 2 chargers may need two transformers—one to go from medium voltage on a voltage distribution line to 480V, and another to go from 480V to 208V or 240V. To provide the required lower voltage power to the AC Level 2 chargers, voltage transformers are provided These can be provided to provide power at the correct voltage to 1, 2, 3 or more Level 2 chargers. In one example, each Level 2 charger has a dedicated voltage transformer, which may be mounted near it, integrated into the power distribution system, or constructed as part of the Level 2 charger. In another example, one voltage transformer may provide power for 2, 3, or 4 Level 2 chargers that are mounted on a common structure or integrated into the power distribution system to transform the supplied voltage into an appropriate utilization voltage of the charger.

Additionally, low power chargers generally output AC power, requiring vehicles to have both an AC input port and on-board power inverter and a DC input port. In the case where EV chargers provided DC input at all power levels, AC chargers could be eliminated. However, DC chargers are required to provide galvanic isolation from all other chargers and the utility grid. Therefore using a single DC power feed requires that each charger have an integrated isolation device. In designing an EV charging site with mixed charger types, a decision is normally made about transformer sizing to accommodate the AC Level 2 chargers. Any significant change in the number of AC Level 2 chargers on the site may result in either excess (and thus inefficient) transformer capacity or require an expensive transformer upgrade. Additionally, any change in the number of Level 2 chargers may require a change in the transformer. By providing individual transformers dedicated to 1, 2, 3, or 4 Level 2 chargers, the modularity increases the flexibility to change charging on the site over time. Using individual transformers also allows those transformers to be disconnected when not in use, increasing energy efficiency of the site and increasing service life of the system.

To address the above-mentioned challenges, an individual transformer or voltage converter 310 may be employed for each Level 2 EV charging station 120, charging stations can be added or removed in any quantity or combination at any time without impacting other parts of the system. By locating the transformers 310 close to the Level 2 EV charging stations 120, conductor size can be minimized, hardware enclosure sizes can be reduced, and National Electric Code tap rules may allow for the elimination of disconnect switches. Additionally, the small size of the individual transformers may allow for innovative and inexpensive mounting solutions of the transformers on or in existing structural power distribution elements. The transformers 210 may be contained in a separate enclosure or incorporated into the same enclosure as the Level 2 EV charging station, or they may be unenclosed.

Electrically, either one phase and a neutral or two phases of a three-phase power system 320 are used to power the transformer and create the 240-volt or 208-volt single-phase power for the Level 2 EV charging stations 120. Each phase can power multiple transformers depending on sizing of the conductors and circuit protection. Alternatively, the EV charging stations 120 may be DC output chargers, utilizing either a DC or AC input. This may allow the transformers 210 to be eliminated.

### Centralized Galvanic Isolation of EV Charging Stations

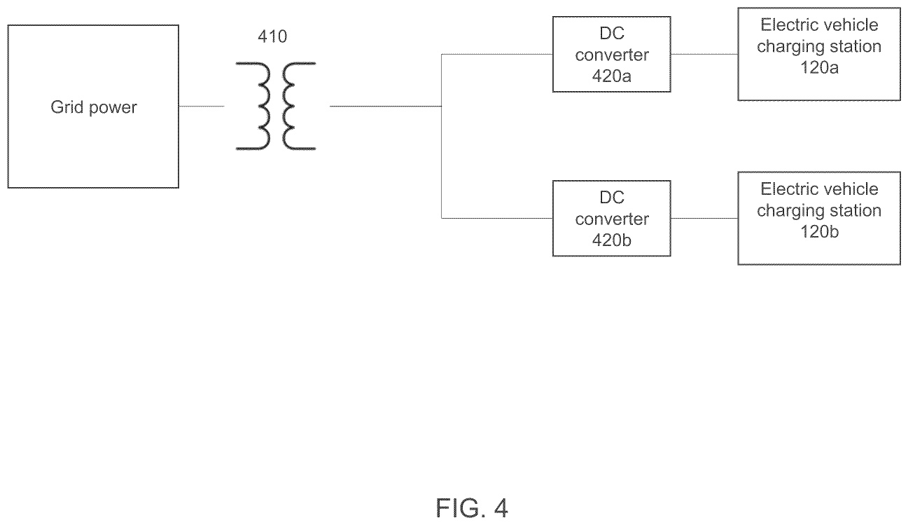

The EV charging stations 120 described herein may be required to be galvanically isolated (e.g., via a transformer) from the grid. Galvanic isolation may be a costly requirement. Centrally locating galvanic isolation as schematically illustrated in FIG. 4 may result in cost savings. A single, high-frequency transformer 410 may galvanically isolate the EV charging stations 120 from the grid and may have multiple taps that are used to feed individual EV charging stations 120. The EV charging stations 120 may be mounted and connected via a tether (1) on a pole, (2) within an overhead connection, (3) on the ground, or (4) underground. A local DC converter (e.g., DC converter 420a or 420b) may serve each EV charging station and regulate the power flowing into the EV. Voltage regulation among the various feeds may be difficult because cross regulation may be likely. Scheduling concurrent loads (e.g., in a fleet application) may reduce cross-regulation issues, and clamping devices may be used to control excess voltage. Clamping devices may also (1) shunt power back into the high-frequency transformer, (2) shunt power to another load, or (3) scale back the duty cycle of the converter for lower overall power transmission. Dynamic impedance control of the loads may be also be used. For example, a DC charger may be able to pulse power into a battery to consume an excess amount of power. In dire, critical circumstances, vehicles may be commanded to turn on air conditioners (or other large power consumers) to bleed off excess power.

In another embodiment, consolidated galvanic isolation systems that feed clusters of EV chargers are distributed along a DC distribution system. For example, a cluster of 4 DC supplied EV chargers are located such that a single DC galvanic isolation converter supplies a smaller number of DC supplied EV chargers. These distributed galvanic isolation converters may be placed within the Fast Connect and cooled via coolant that runs within the plenum containing the bus and other components. A lager non-isolated or isolated DC converter may then be used to supply power to several of these distributed galvanic isolation devices.

### Modular Systems

Multiple DC converters that supply a DC bus may be arranged in parallel to provide larger overall capacity and a measure of redundancy. The multiple DC converters may be connected to multiple loads (e.g., EV charging stations). The loads may or not be connected in parallel. Alternatively, the DC converters may be connected to a single load (e.g., a single large EV charging station). The single load may be connected to the DC converters via a single cable or bus or multiple cables or buses.

A modular EV charger may be dynamically configurable to draw power from two or more DC converters. In one example, an EV charger can draw power from 4 25 kW DC converters, 2 50 KW DC converters or 1 100 KW DC converters. Two EV chargers may be combined to form a single EV charger. A single cable or set of cables may be used to provide all or part of the power for the single EV charger.

In some cases, the EV chargers described herein may be quad-port EV charger. In cases in which three vehicles are connected to a single quad-port EV charger, one may be limited to 15 KW (e.g., either by design or command) and the others may be able to sustain 50 KW or more. Smaller EV chargers may be installed to prevent the connected EVs from disconnecting during periods of idle or power below the quad-port EV charger threshold.

Series-connected contactor arrays may be installed to permit isolation of various DC converters from each other and/or from other loads. Alternatively, series-connected silicon or other semi-conductor switches with bi-directional blocking elements may be used for the same purpose. Small, isolated power supplies may be installed on the outputs of each DC converter capable of supplying power to any given EV load to prevent undervoltage lockout due to power loss. Multiple windings may be present and connected in parallel to supply the power necessary to charge a given load. A separate, isolated bank of DC converters may be placed in parallel with the larger DC converters, with each supply dedicated to a specific load. Sensors may be installed at multiple points of the EV charging station and individual EV chargers to detect and automatically act based on fault conditions, including any fault to ground. These sensors and associated relays and other devices may provide a similar or higher degree of safety as compared to galvanic isolation and may be able to negate the need for galvanic isolation transformers.

### Common DC Bus Architecture

Multiple battery energy storage systems may be connected via a common DC or AC bus feeding the DC chargers; power flow can be regulated to control the overall current across any one conductor segment. The method of control may be one of the following: (1) direct communication via external connection, (2) monitoring of DC bus voltage, (3) injection of a high frequency signal onto the DC bus, (4) time of day rates, or (5) Open Charge Point Protocol load aggregation.

In a ring connected network, or a network that has several cross-conducting paths, current may be steered by dynamic control of the loads and sources. For example, multiple chargers may be connected to a single segment. The main DC supplies may be battery energy storage systems that are connected across the same segment. Chargers in the middle may request high amounts of power, resulting in excess current flow. The battery energy storage systems may then be commanded to supply additional power to prevent the outer segments from being overloaded. Artificial intelligence may be leveraged to dynamically control loads and sources to prevent any one segment from overloading. Power flow across the DC system may be managed by active controlling the battery energy storage systems.

System reliability may be improved by segmenting the grid. The grid may be segmented via active (e.g., a contactor) or passive (e.g., a fuse) means. Alternatively, the grid may be segmented via a series connected power conversion device. Such a device may (1) shunt current to ground for overvoltage or overcurrent faults, (2) shunt current via a high/moderate impedance across the phase conductors, or (3) increase the series impedance of a given segment.

### Rapid-Disconnect for Mobile EV Charging Stations

In some cases, the battery energy storage systems 130 and the EV charging stations 130 are configured to be easily connected and disconnected from the EV charging site 100 so that the EV charging site 100 can be reconfigured as demand changes. The battery energy storage systems 120 and the EV charging stations 130 may also be easily transportable.

The battery energy storage systems 130 may be affixed to a skid or trailer for easy transport means. The battery energy storage systems 130 may be connected to chargers, the main utility feed, and other devices via an overhead bus, or within the skid. The skid may have forklift pockets or lifting eyes to facilitate easy transport.

The battery energy storage systems 130 and the EV charging stations 130 may be preconnected on the skid or trailer for rapid installation. The battery energy storage systems 120 and the EV charging stations 130 may be connected to grid power by a rapid disconnect plug or umbilical permitting easy transport. The skid may be installed with fuses (or other Over Current Protection—“OCP”) and a transformer to allow for quick transport. The skid may be installed on a trailer, roll back or other device to permit easy transport such that it may be pushed, pulled or lifted off the trailer. Cabling may be bundled within an OH duct or within the skid to permit easy transfer and field assembly. The ducting may be unfolded or slide apart to deploy the chargers far enough apart to permit easy connection to various vehicles. Batteries may or may not be installed depending on the style of battery to be deployed. The skid may have features that facilitate resting it on concrete, piers, or gravel. In cases where the substrate is slick or not stable, screws, nails, or staples may be preinstalled on the skid to permit rapidly securing of the battery energy storage systems and EV charging stations. The system may be installed anywhere where the input voltage is compatible with the input (e.g., a mobile generator).

In some cases, the battery energy storage systems 130 may be ruggedized for use in harsh environments. For example, the battery energy storage systems 130 may have vents that are equipped to minimize spark or ember uptake, exteriors that are coated in flame retardant, and fire-proof insulation. The battery energy storage systems 130 may be ballistically hardened or camouflaged. The battery energy storage systems 130 may be equipped with protection from electromagnetic pulses, such as grates, surge protection, or other dissipative devices. In some cases, the battery energy storage systems 130 may be covered with faraday cages or shields to permit rapid deployment.

### Backplanes for Easy Installation of Electronics

The EV charging stations 120 and/or the battery energy storage systems 130 and or power distribution system (FastConnect) may have backplanes, conductive bussing, or structure that facilitate rapid and easy connection to the utility feed and power electronics (e.g., inverters, transformers, sensors, accessories, and the like). The backplanes may be similar to server backplanes. The backplanes may have electrical connectors and pins. The electrical connectors and pins may include spring-loaded clamp connectors. The backplanes may have computer busses. The backplanes may be located on the top, bottom, or rear sides of the EV charging stations 120 or the battery energy storage systems 130 or the power distribution system enclosure. The backplanes may have rubber curtains, baffles, or gaskets that seal the electrical connectors and pins from outside elements, including rain, dust, insects, rodents and other debris. Optionally, the backplanes may have covers that prevent the connectors and pins from becoming damaged or soiled.

### Overhead Cable or Bus Bar

The EV charging stations 120 and battery energy storage systems 130 may be connected to the main utility feed via an overhead cable or bus bar, underground conduit, or ground-mounted cable way.

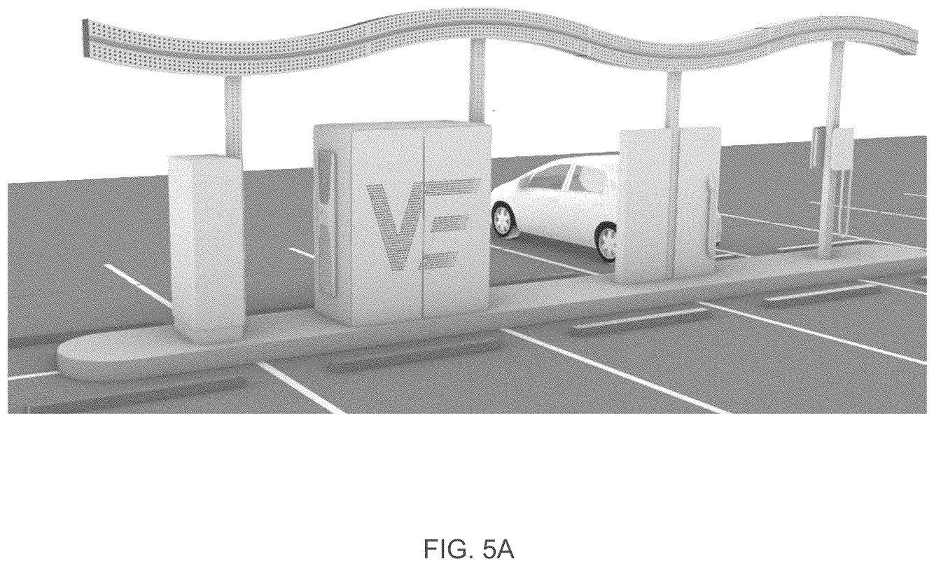

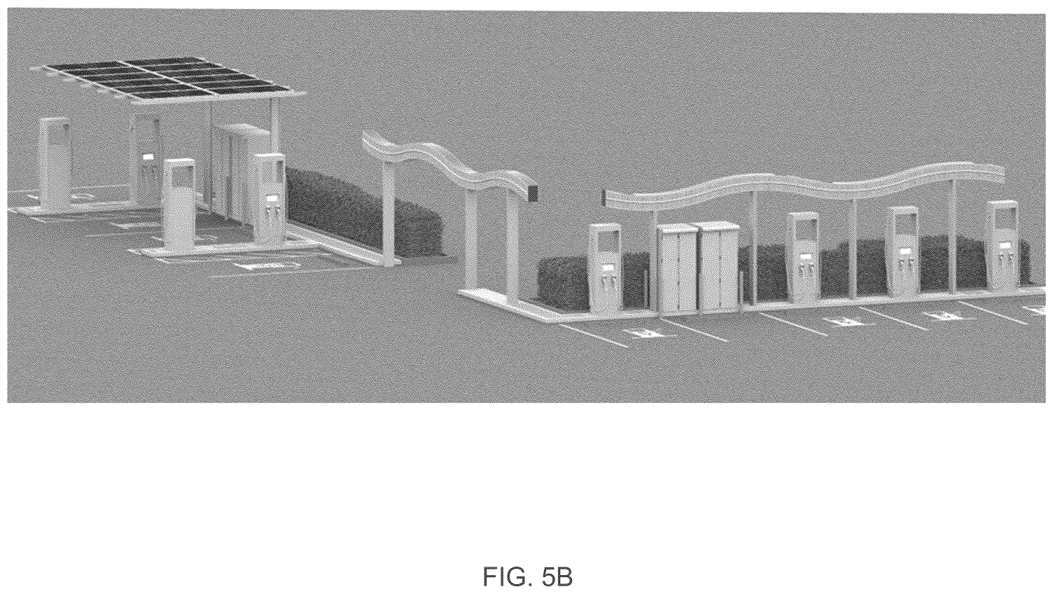

FIGS. 5A-5B depict an example of such an overhead bus bar. The overhead bus bar may have a wavelike shape, may be horizontal (straight), or have another shape. The overhead bus bar may be designed to support electrical infrastructure, including power and communication distribution, as well as other services (e.g., area lighting, security lighting, security cameras, advertising and advertising support, equipment support, wayfinding, wireless connectivity, etc.). The overhead bus bar and its supports may also have charger electronics, controllers, transformers, over current protection, relays, sensors (e.g., power and temperature sensors for controlling power flow), and the like.

The overhead bus bar may allow natural or forced airflow around the conductors that provide power to the EV charging stations 120 and the battery energy storage systems 130, to allow a reduction in the conductor size for a given ampacity. This environment inside the cable bus may be considered “free air” by the National Electrical Code (“NEC”), thus allowing “free air” ampacity ratings instead of ratings based on being in conduit, or some other reduction of conductor size allowed through testing and certification. Conductors' ampacities may also be varied by temperature or other operating condition or environment of the conductors through both active sensing and default parameters. This could include inputs from conductor temperature sensors, ambient weather conditions from external data or local sensors, power flow from sensors or external data such as from EV charger data, current flow, or other device or data set.

The bus bar may intrinsically provide separation of voltages through its construction through the use of dielectric dividing elements or multiple parallel busses. The bus bar may provide separation between feeders and load circuits, low voltage signaling, lighting or other load, and/or communications as required by code. Battery energy storage systems may be directly connected to the bus bar feeder conductors while they are energized (e.g., a “hot tap”).

The vertical legs of the bus bar may provide structural support to the bus bar. In some cases, the structural supports may provide seismic support. The vertical legs may provide a pathway to the ground level for the power and communications cabling (e.g., using the leg as a method to directly bring conductors to the ground, or to house a conduit for the same purpose). Every charger may have a vertical leg associated with it to provide a path for its power and communication cabling; consequently, the vertical leg may additionally be used for EV charging cable management. One difficulty of EV charger cable management may be finding a support point that is high enough to hold enough EV car charging cable and provide enough additional length when extended. The vertical legs can provide such a high support point Any required retraction mechanism (spring, cable, weight, etc.) can be housed inside or outside the vertical leg.

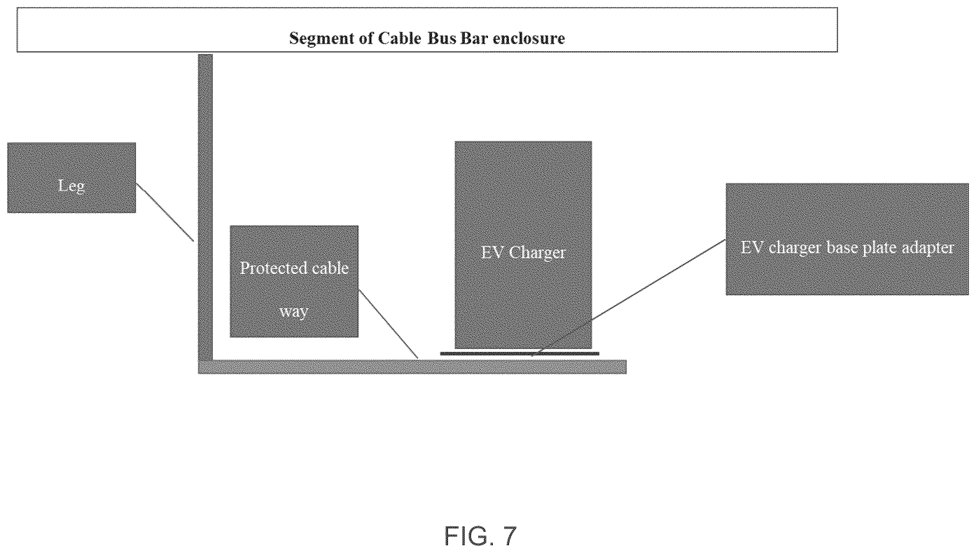

The vertical legs may provide support for the disconnect switches if required for higher-powered chargers. The vertical legs may provide support for the smaller Level 2 chargers and associated transformer. The Level 2 chargers may optionally be housed in the overhead bus bar itself, with only the charging cords dropping out of the overhead system. The vertical legs may contain payment or other charging activation systems. FIG. 7 schematically illustrates a side view of the EV charging environment. The vertical legs may terminate in a conduit that penetrates the concrete or other leg base providing a route for the cabling to get to the charger. Alternately, the leg may have an opening in the bottom side to allow cabling to exit into a protected cable way mounted directly to a concrete pad or other support base. Such protected cable way may also extend under the EV charger. Such protected cable way may also provide a mounting base for the EV charger, with the mounting base easily changed to adapt to many different EV charger bases. Such protected base may allow the cabling to be fed into the bottom of the EV charger without penetrating the concrete or other base. Alternately, the protected cable way may be an extension of the base of the energy storage system extended beyond the energy storage system to under an EV charger or other device. Cabling could run from the energy storage system through the protected cable way to the EV charger or other device. The cabling may run in a cableway with removable covers. Space inside the horizontal enclosure of the bus bar may also be used to transmit, aggregate and control communications, lighting, camera, and other systems as well as power supplies, routers, transmitters, WiFi and cellular communications. It may also be used to house piping and fluid transfer and control systems for use in cooling other devices using a central cooling system. The fluid piping may also be carried down into the legs and cable ways along side the cables. In a code compliant system, the sizing of a conductor, including tap conductors, is limited to just the maximum current carrying capacity (per specific Code guidelines) at a given temperature or installation condition (i.e., as within a conduit or raceway). The conductor must be sized to the delivered load or set of loads, or set of loads following a demand factor, typically at its maximum consumption rating, and this may result in over sizing of the feeder, tap conductor, or other conductor supplying current to the system. A dynamically configurable system with sufficient metering (current sensor) at each node to permit load current calculations to be performed, may allow a load management system (or EMS) to dynamically limit the available power (current) flow on a conductor as limited by series connected and dynamically configured OCP devices. This permits the conductor to be sized for optimal economic or site conditions, environmental (ambient temperature or other conditions) instead of total load capacity. Various distributed energy resource management system (DERMS) or BESSes may be connected at any point along the system and managed via dynamic dispatch from the load management system (LMS), energy management system (EMS), or system protection system, additionally, current that may be flowing into a fault, short, malfunctioning device, or other may easily be detected by the site EMS/LMS system.

### Battery Energy Storage Systems

The battery energy storage systems 130 described herein may have multiple sub-assemblies, including battery modules, battery management systems (“BMSs”), power conversion systems (“PCSs”), power distribution equipment, control and communications equipment, cable ways, bases, and environmental conditioning systems. In traditional battery energy storage systems, such sub-assemblies may be in a single enclosure. Alternatively, a single enclosure may house some components, with other components (e.g., environmental conditioning units, PCSs, and power distribution equipment) mounted exterior to the battery energy storage system. When all sub-assemblies are housed in a single enclosure, newer certification standards may require extensive testing, including burn-down tests, to be conducted on the entire unit when any major component is changed. This constricts supply chain flexibility, slows innovation, and increases the cost of changes. Also, it may be desirable to have all components be internal to the cabinet to provide better aesthetics, simpler transportation to a site, simpler installation, and greater resistance to damage and vandalism. Additionally, with all components inside, and no access required on either end of any cabinet, an infinitely long lineup of battery energy storage systems 130 can be installed end-to-end.

One way to achieve both the advantages of a single cabinet installation and the flexibility of not retesting all sub-assemblies when any item is changed is to segregate the sub-assemblies into different cabinets that are connected by large openings to allow for the passage of power and communications cables and airflow for environmental control. However, the presence of the large opening may result in the cabinet being viewed as single enclosure from the perspective of fire testing or code enforcement. One way to separate the enclosure spaces, while maintaining the open physical connection, is to install a fire damper in the opening The fire damper may be rated to maintain fire separation between the different cabinet areas. The fire damper may be actuated by a fusible link or actuator and may be manually or automatically openable after closure. The fire rating may be provided by the metal wall of one cabinet, the metal wall of the adjacent cabinet, and any air gap between the cabinets. The gap may be less than an inch, or it may be over a foot. The air gap may have an aesthetic collar around the fire damper sleeve and communications equipment that runs between the cabinets. The sleeve may make the cabinets appear as one cabinet, or as two individual cabinets with a gap. The fire rating may be enhanced by installing certain types of insulation (e.g., mineral wool fiber) on the cabinet walls and roof or throughout the cabinet.

The cabinet may also include a separate fire, smoke, or combination sensor, with local and/or remote alarming capability either through the normal communications system or a dedicated communication system. The sub-assemblies may be segregated such that the flexibility of the supply chain and/or product mix is most enhanced. In one embodiment, the battery modules and BMS may be in one cabinet, while the PCS, power distribution equipment, control and communications equipment, and environmental conditioning system are in another cabinet. This may allow testing only the cabinet with the battery module to use an alternate battery supplier. In another embodiment, the battery module includes the environmental conditioning system for the module. This decouples the sizing of the battery environmental conditioning system from the PCS environmental condition system and allows an infinite number of battery modules to be installed without impacting the PCS environmental system.

Further utility and increased ability to segregate based on stopping the spread of fire is provided by including additional methods of communication services between enclosures, including, but not limited to, communications headers, buss bar connections for power, conduit sleeves, nipples, or constructed raceways with included or separately added intumescent materials. The separate panels may include expulsion panels to reduce the pressure inside the separate cabinet to protect the integrity of a closed fire damper. Each cabinet may have an environmental conditioner included, or environmental conditioning may be shared between cabinets with or without booster fans to enhance air circulation. Expulsion systems may also be integrated into other components, or other components may have systems separately certified, or used without certification, for pressure expulsion.

Another way to achieve both the advantages of a single cabinet installation and the flexibility of not retesting all sub-assemblies when any item is changed is to segregate the sub-assemblies into different cabinets that rest on individual modular or unified plinth bases. In this embodiment, all AC, DC, and communication cables, as well as cooling fluid and compressed air hoses and pipes, or other services, are routed through the bottom of the PCS cabinet, through channels in the plinth base, either dedicated per service or grouped, and then rise through the cabinet base of the module they connect to. Connections may be made in the plinth base or in the individual module cabinets. Modules may be separated, allowing bollard placement adjacent to the BESS plinth. In this embodiment, no airflow is required to pass between the cabinets, and no holes are required to be made in the adjoining cabinet sides. This plinth may extend beyond the base of the battery energy storage system to allow 3^{rd} party devices, such as EV chargers, fluid coolers, transformers, other electrical or mechanical devices etc., to be mounted on it, potentially using a custom mounting adapter plate, to transfer services from and to the battery energy storage system and into the other distribution systems. Thus, the plinth can be extended beyond the BESS and to, or under other devices to pass cables to the other device. The extended plinth may also contain metering or sensor devices as well as integrated OCP devices. The plinth may also be fitted with an adapter plate permitting various EV chargers or other devices to be installed; the plinth may also contain features permitting seismic or other building site requirements to accommodate a variety of such mechanical loads. Channels, raceways, or ducts may be used to route power, signal, coolant or other lines or pipes. The plinth or base may be sized such that it matches the size of the enclosure above it. In addition, the plinth may function as a wire or coolant pipe way or chase. The plinth may also be used to locate the cabinet during installation. The plinth is pre-installed prior to the cabinet being placed upon it. The plinth may contain features that permit leveling or slight side to side adjustment of the cabinet if necessary. The plinth may contain the appropriate bonding features to permit rapid and solid earth ground bond connection.

Each battery cabinet may have a hose connection. The hose connection may be in the top of the battery cabinet. The hose connection may be a standard fire hose quick connection, standard threaded connection, or specialized connection for long-distance operation. Alternately, the cabinet may have a panel that can be forced open when hit with a high-pressure stream of water, allowing water to enter the cabinet without the need for a fire fighter to approach the cabinet.

Any cabinet with the ability to have water introduced into it for fighting fires may also have a drain at the bottom that automatically operates based on a signal (e.g., a signal from a temperature sensor or moisture sensors), loss of control power, or manually. Similarly, the cabinet may have a connection for a firefighting chemical agent to be connected, injected, or otherwise dispersed into the cabinet while the cabinet has an active fire or after an active fire.

The fire dampers, communications headers, conduits and raceway sleeves may all be prefabricated on a panel equal in size to a standard access plate such that a prefabricated fire damper assembly panel may be used in place of an access panel, and an access panel may be use in place of the fire damper assembly panel, either in the factory or in the field, using the same fasteners and sealant materials for each.

### Solar and Other Energy Sources

Other types of energy sources (e.g., solar, wind, hydrogen, battery energy storage systems) may be connected to the AC or DC grid. Passive modulation of power flow may occur via control of AC or DC voltage on a time-synced basis from (1) a synchronized clock (2) a signal present on the bus (3) a signal via communications, or (4) a 60 Hz AC signal (e.g., one used in power supplies for the various power source equipment). The flow of power within the grid may then be modulated to control power flow within a segment. AI management of the system may automate control of the system. Sources may be scheduled for power production based on tariffs, operations & maintenance costs, fuel costs.

In some cases, the EV charging sites described herein may be connected to one or more solar panels. The EV charging sites may implement maximum power point (MPPT) tracking through direct and indirect sensing of ambient conditions or infrared detection of ambient light levels or heat rise. Information may be collected via an application programming interface (API) from a controller or other device or communication via charger. The above information can then be used to reset or otherwise alter the setpoints within the inverters or MPPT controllers to another commanded value. The expected output of various solar arrays may be pre-programmed or otherwise transmitted to the local system based on ambient conditions (e.g., detected by weather station or local or remote sensors). Decisions can then be made as to the relative health of the system based on dynamic performance. The local EMS can then cause the inverters to reset by cycling contactors, allowing the common DC bus voltage to drift to high, forcing the solar inverters to go into a clipping state.

In AC systems, passive series or parallel impedances may be used to alter the power factor, voltage, to steer the power flow across the network. Devices may be bypassed via mechanical (e.g., contactor) or active (e.g., power conversion) means. For example, an active power flow device such as a unified power flow device may be used to steer power flow. Parallel connected or series injection transformers or impedances may be used to balance the power (or cause an imbalance) across phases. For example, parallel connected or series injection transformers may be used to alter the impedance causing the power to flow along desired paths. The reported supplied power of the solar or PV source (or other device) may be used in place of power current sensors placed at the conductor. The solar or PV source (or other) typically provides an average flow parameter via industrial communications protocol and are not typically cable of providing sufficient fault clearing current to activate a passive short current limiting device (like a fuse); as the fault clearing current/energy flows from the utility, an increase in current or spike in energy or a rapid alteration of the voltage or current waveform may be observed by an upstream device indicating a fault with a conductor has occurred. Further, if the source (PV or other) indicates that power is indeed flowing and other sensors are not corroborating the power flow, a fault may be reported. Upon such reporting, an action may be taken to prevent damage to device or conductor.

### Arc-Fault Disconnects

Arc-fault circuit (“AFC”) detection devices may be used to enhance the safety of each EV charging station 120. A local power converter, disconnect, shunt trip device, or other means may be used to disconnect the power flow to the vehicle in the presence of a series or parallel fault The AFC detection devices may not be located within the EV charging stations. An arc-fault may be the result of a broken cable or connector within the EV load or within the distribution network. To prevent arc-fault detection circuits from causing false trips (or tripping/disconnecting multiple EV chargers/loads), a series or parallel impedance may be installed to prevent signal propagation Alternatively, a burst of electromagnetic interference with a known signature may be injected onto the distribution system. The burst may signal to other devices that a short has been detected and will be shutting down. The burst may contain information such as magnitude, phase, or other information to assist in the determination of which AFC device is closest to the fault—and therefore only tripping the unit closest to the fault.

### Computer Systems

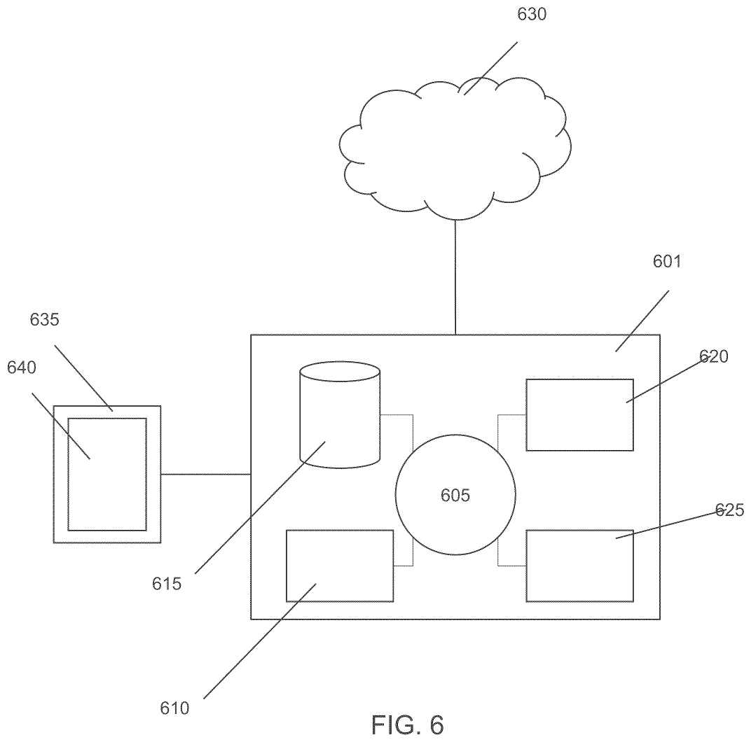

The present disclosure provides computer systems that are programmed to implement methods of the disclosure. FIG. 6 shows a computer system 601 that is programmed or otherwise configured to control the EV charging stations 120 and the battery energy storage systems 130 of FIG. 1. The computer system 601 can regulate various aspects of the present disclosure. The computer system 601 can be an electronic device of a user or a computer system that is remotely located with respect to the electronic device. The electronic device can be a mobile electronic device.

The computer system 601 includes a central processing unit (CPU, also “processor” and “computer processor” herein) 605, which can be a single core or multi core processor, or a plurality of processors for parallel processing. The computer system 601 also includes memory or memory location 610 (e.g., random-access memory, read-only memory, flash memory), electronic storage unit 615 (e.g., hard disk), communication interface 620 (e.g., network adapter) for communicating with one or more other systems, and peripheral devices 625, such as cache, other memory, data storage and/or electronic display adapters. The memory 610, storage unit 615, interface 620 and peripheral devices 625 are in communication with the CPU 605 through a communication bus (solid lines), such as a motherboard. The storage unit 615 can be a data storage unit (or data repository) for storing data. The computer system 601 can be operatively coupled to a computer network (“network”) 630 with the aid of the communication interface 620. The network 630 can be the Internet, an internet and/or extranet, or an intranet and/or extranet that is in communication with the Internet. The network 630 in some cases is a telecommunication and/or data network. The network 630 can include one or more computer servers, which can enable distributed computing, such as cloud computing. The network 630, in some cases with the aid of the computer system 601, can implement a peer-to-peer network, which may enable devices coupled to the computer system 601 to behave as a client or a server.

The CPU 605 can execute a sequence of machine-readable instructions, which can be embodied in a program or software. The instructions may be stored in a memory location, such as the memory 610. The instructions can be directed to the CPU 605, which can subsequently program or otherwise configure the CPU 605 to implement methods of the present disclosure. Examples of operations performed by the CPU 605 can include fetch, decode, execute, and writeback.

The CPU 605 can be part of a circuit, such as an integrated circuit. One or more other components of the system 601 can be included in the circuit. In some cases, the circuit is an application specific integrated circuit (ASIC).

The storage unit 615 can store files, such as drivers, libraries and saved programs. The storage unit 615 can store user data, e.g., user preferences and user programs. The computer system 601 in some cases can include one or more additional data storage units that are external to the computer system 601, such as located on a remote server that is in communication with the computer system 601 through an intranet or the Internet.

The computer system 601 can communicate with one or more remote computer systems through the network 630. For instance, the computer system 601 can communicate with a remote computer system of a user (e.g., a computer system within a vehicle). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 601 via the network 630.

Methods as described herein can be implemented by way of machine (e.g., computer processor) executable code stored on an electronic storage location of the computer system 601, such as, for example, on the memory 610 or electronic storage unit 615. The machine executable or machine-readable code can be provided in the form of software. During use, the code can be executed by the processor 605. In some cases, the code can be retrieved from the storage unit 615 and stored on the memory 610 for ready access by the processor 605. In some situations, the electronic storage unit 615 can be precluded, and machine-executable instructions are stored on memory 610.

The code can be pre-compiled and configured for use with a machine having a processer adapted to execute the code or can be compiled during runtime. The code can be supplied in a programming language that can be selected to enable the code to execute in a pre-compiled or as-compiled fashion.

Aspects of the systems and methods provided herein, such as the computer system 601, can be embodied in programming. Various aspects of the technology may be thought of as “products” or “articles of manufacture” typically in the form of machine (or processor) executable code and/or associated data that is carried on or embodied in a type of machine readable medium Machine-executable code can be stored on an electronic storage unit, such as memory (e.g., read-only memory, random access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 601 can include or be in communication with an electronic display 635 that comprises a user interface (UI) 640 for providing, for example, payment functionality for an EV charger. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 605.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1.-38. (canceled)

39. A system, comprising:
an electrical load comprising an electrical vehicle (EV) charging site, wherein said EV charging site comprises a plurality of EV chargers and a plurality of battery energy storage systems;
a main utility feed that connects said electrical load to a power grid, wherein said main utility feed has a power capacity;
a sensor configured to measure power on said main utility feed; and
a controller communicatively coupled to said sensor and said plurality of battery energy storage systems, wherein said controller is programmed to cause:
(i) a subset of said plurality of battery energy storage systems to charge using power from said main utility feed when said power on said main utility feed does not exceed a threshold, and
(ii) a subset of said plurality of battery energy storage systems to discharge power when said power on said main utility feed does exceed said threshold.

40. The system of claim 39, wherein said electrical load further comprises a building, and wherein said discharged power in (ii) is transmitted to said building.

41. The system of claim 39, wherein said discharged power in (ii) is transmitted to said plurality of EV chargers.

42. The system of claim 39, further comprising a conductor in electrical communication with said main utility feed, wherein said conductor transmits power to one or more EV chargers of said plurality of EV chargers and one or more battery energy storage systems of said plurality of battery energy storage systems.

43. The system of claim 42, wherein said conductor is disposed in an overhead cable or bus.

44. The system of claim 43, wherein said overhead cable bus comprises a support leg adjacent to an EV charger of said one or more EV chargers.

45. The system of claim 44, wherein said support leg comprises an internal cavity for routing power and communication cables to said EV charger.

46. The system of claim 43, wherein said overhead cable bus comprises lighting.

47. The system of claim 43, wherein said overhead cable bus comprises one or more electronic displays.

48. The system of claim 39, wherein said plurality of battery energy storage systems are interspersed with said plurality of EV chargers.

49. The system of claim 39, further comprising one or more renewable energy sources.

50. The system of claim 49, wherein said one or more renewable energy sources comprise a solar array or a wind turbine.

51. The system of claim 49, wherein said controller is programmed to implement maximum power point tracking of said one or more renewable energy sources.

52. The system of claim 39, wherein an EV charger of said plurality of EV chargers is installed with an arc-fault detection device.

53. The system of claim 52, wherein said arc-fault detection device comprises a series or parallel impedance configured to prevent propagation of an arc-fault detection signal.

54. The system of claim 39, wherein a battery energy storage system of said plurality of battery energy storage systems comprises a plurality of cabinets.

55. The system of claim 54, wherein said plurality of cabinets are connected via openings.

56. The system of claim 55, wherein said openings comprise fire dampers.

57. The system of claim 56, wherein said openings are between plinth bases under the cabinets.

58. The system of claim 39, wherein a battery energy storage system of said plurality of battery energy storage systems comprises an environmental conditioning unit.

59. The system of claim 39, wherein a battery energy storage system of said plurality of battery energy storage systems comprises a hose connection.

60. The system of claim 39, wherein a battery energy storage system of said plurality of battery energy storage systems comprises a water drain.

61. The system of claim 39, wherein said battery energy storage system comprises a heat or smoke sensor, wherein said heat or smoke sensor is communicatively coupled to said controller.

62. The system of claim 39, wherein said plurality of EV chargers or said plurality of battery energy storage systems are disposed on a skid.

63. The system of claim 39, a battery energy storage system of said plurality of battery energy storage systems comprises one or more electrochemical cells or other energy storage.
